(19) United States
(12) Patent Application Publication
(10) Pub. No.: US 2024/0396935 A1
(43) Pub. Date: Nov. 28, 2024

(54) LOCATION VERIFICATION THROUGH VISUAL POSITIONING

(71) Applicant: Niantic, Inc., San Francisco, CA (US)

(72) Inventors: Jannis Kirschner, Basel (CH); Severin Wischmann, Zurich (CH); Brian McClendon, Lawrence, KS (US); Benedikt Troster, Zurich (CH); Chikai Ohazama, San Francisco, CA (US); Victor Adrian Prisacariu, London (GB); Ben Benfold, Oxford (GB)

(21) Appl. No.: 18/675,607

(22) Filed: May 28, 2024

Related U.S. Application Data
(60) Provisional application No. 63/504,542, filed on May 26, 2023.

(51) Int. Cl. H04L 9/40; A63F 13/216; A63F 13/655; A63F 13/75; G06T 7/70

(52) U.S. Cl. CPC H04L 63/1466; A63F 13/75; G06T 7/70; A63F 13/216; A63F 13/655

(57) ABSTRACT

An online system uses a visual positioning system (VPS) model to verify the location of a client device for anti-spoofing measures. The online system receives ostensible pose data and image data from the client device. This pose data and image data are ostensibly captured by the client device at the same time, or within some threshold time of each other. The online system determines whether they match according to a VPS model. The online system uses the VPS model to output candidate poses for the client device based on the received image data and compares those candidate poses to the pose in the received pose data. If the differences between the candidate poses and the pose from the received pose data exceed a threshold, the online system may determine that the received pose data and image data do not match and thus are likely being spoofed.

### CROSS-REFERENCE TO RELATED APPLICATIONS

This application claims the benefit of U.S. Provisional Application No. 63/504,542, entitled “VPS-Based Location Verification” and filed May 26, 2023, which is incorporated by reference.

U.S. Pat. No. 11,325,042, entitled “Verifying a Player's Real World Location using Image Data of a Landmark Corresponding to a Verification Pathway,” filed Sep. 29, 2020, is incorporated by reference. The '042 patent describes some example contexts in which the description below can be used. U.S. patent application Ser. No. 17/879,718, entitled “Simulated Consistency Check for Points of Interest on Three-Dimensional Maps,” filed Aug. 2, 2022, is by reference. The '718 application describes some example contexts in which the description below can be used.

### BACKGROUND

Online systems can provide location-based features to users. These systems determine a location of the user based on location data received from the user's client device. If the user is at a particular location or if the user is within some geographic region, an online system may provide a particular feature to the user. For example, an online gaming system may provide content with which the user can interact if the user is within some threshold distance of some landmark. Similarly, an online streaming system may restrict whether it streams a video to a client device based on the location of the device. These features may even be pose-specific, with the online system determining a pose (i.e., location+orientation) of the client device based on pose data captured by the client device and providing features or services to users based on the pose of their client device.

However, malicious actors may try to take advantage of pose-based features or services by “spoofing” their pose. That is, a user may provide falsified pose data to the online system to take advantage of the pose-based services without actually being present at the alleged pose. For example, if an online gaming system provides certain game benefits based on how far a client device travels, a maliciously-acting user may provide spoofed pose data that describes the user's client device as moving without the user actually moving. Online systems may require that sensor data from multiple sensors must align to verify a device's pose to make it more difficult for a user to spoof their pose. However, sophisticated spoofing programs can model the sensor output of multiple sensors on a device, meaning these techniques are ineffective.

### SUMMARY

The present disclosure describes an online system that uses a visual positioning system (VPS) model to verify the location of a client device for anti-spoofing measures. The online system receives ostensible pose data and image data from the client device. This pose data and image data are ostensibly captured by the client device at the same time, or within some threshold time of each other. However, the pose data and the image data may be valid data (e.g., they were captured through the proper use of the client device interacting with the online system) or they may be invalid data (e.g., they were not captured by the client device or were captured at different times).

To determine whether the received pose data and image data are valid, the online system determines whether they match according to a VPS model. The VPS model is a model that outputs candidate poses for a client device based on received images. The online system uses the VPS model to output candidate poses for the client device based on the received image data and compares those candidate poses to the pose in the received pose data. If the differences between the candidate poses and the pose from the received pose data exceed a threshold, the online system may determine that the received pose data and image data do not match. If they do not match, the online system may perform a disciplinary action with regards to a user associated with the client device. For example, the online system may disable pose-based services for the client device or may deactivate an account associated with the user.

### BRIEF DESCRIPTION OF THE DRAWINGS

FIG. 1 depicts a representation of a virtual world having a geography that parallels the real world, according to one embodiment.

FIG. 2 depicts an exemplary interface of a parallel reality game, according to one embodiment.

FIG. 3 is a block diagram of a networked computing environment suitable for location verification through visual positioning, according to one embodiment.

FIG. 4 is a flowchart describing an example method of location verification using a VPS model, according to one embodiment.

FIG. 5 illustrates examples of ostensible pose data and ostensible image data that match and that do not match, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where VPS-based pose verification is desirable. In addition, the inherent flexibility of computer-based systems allows for a great variety of possible configurations, combinations, and divisions of tasks and functionality between and among the components of the system.

### Example Location-Based Parallel Reality Game

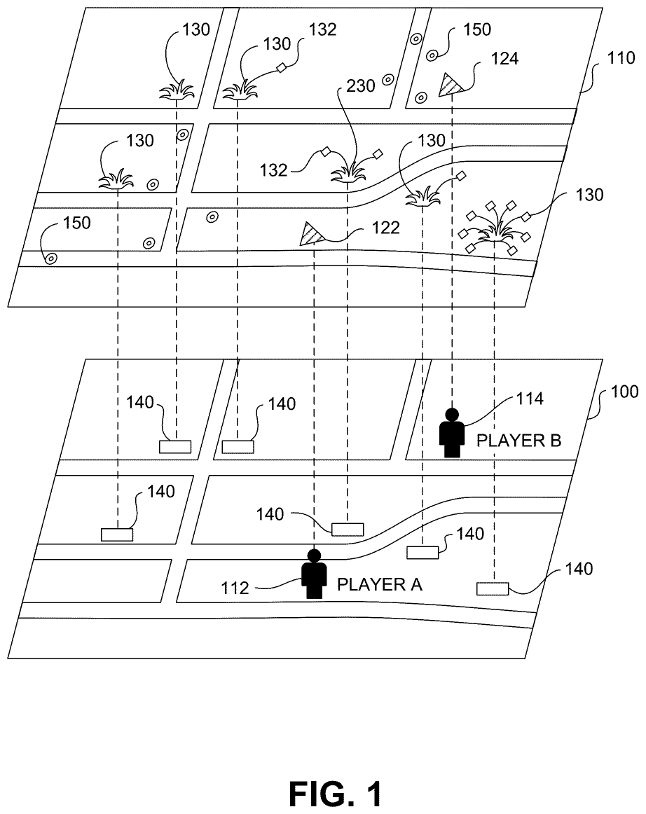

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player's position in the virtual world 110 corresponds to the player's position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player's position as the player navigates the range of geographic coordinates in the real world 100. Data associated with the player's position in the real world 100 is used to update the player's position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

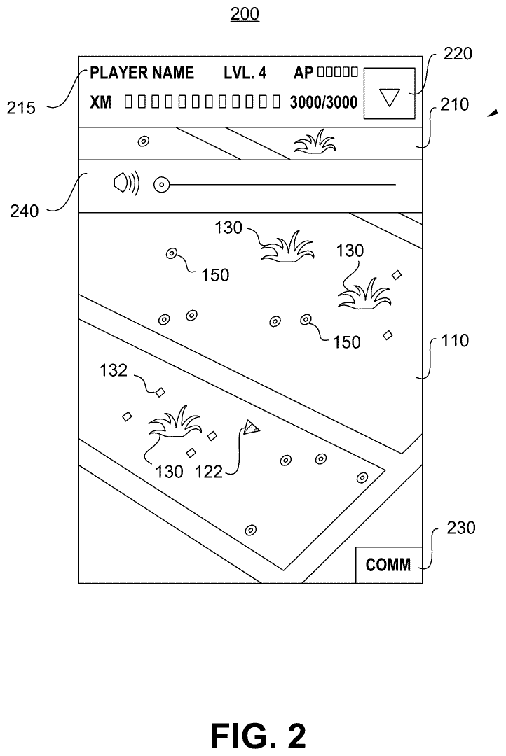

FIG. 2 depicts one embodiment of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Gaming System

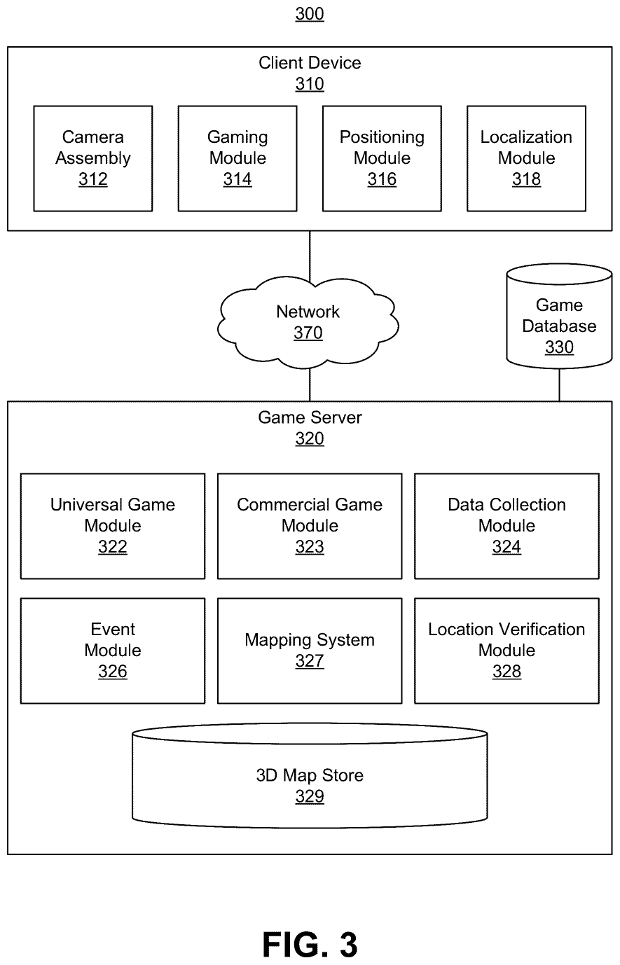

FIG. 3 illustrates one embodiment of a networked computing environment 300. The networked computing environment 300 uses a client-server architecture, where a game server 320 communicates with a client device 310 over a network 370 to provide a parallel reality game to a player at the client device 310. The networked computing environment 300 also may include other external systems such as sponsor/advertiser systems or business systems. Although only one client device 310 is shown in FIG. 3, any number of client devices 310 or other external systems may be connected to the game server 320 over the network 370. Furthermore, the networked computing environment 300 may contain different or additional elements and functionality may be distributed between the client device 310 and the server 320 in different manners than described below.

The networked computing environment 300 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 310 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 310.

A client device 310 can be any portable computing device capable for use by a player to interface with the game server 320. For instance, a client device 310 is preferably a portable wireless device that can be carried by a player, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the game server 320 to provide sensory data of a physical environment. In one embodiment, the client device 310 includes a camera assembly 312, a gaming module 314, a positioning module 316, and a localization module 318. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video.

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g., temperature, brightness of environment, air pressure, location, pose etc.) or capture data (e.g., exposure length, shutter speed, focal length, capture time, etc.).

The gaming module 314 provides a player with an interface to participate in the parallel reality game. The game server 320 transmits game data over the network 370 to the client device 310 for use by the gaming module 314 to provide a local version of the game to a player at locations remote from the game server. In one embodiment, the gaming module 314 presents a user interface on a display of the client device 310 that depicts a virtual world (e.g., renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

The gaming module 314 can also control various other outputs to allow a player to interact with the game without requiring the player to view a display screen. For instance, the gaming module 314 can control various audio, vibratory, or other notifications that allow the player to play the game without looking at the display screen.

The positioning module 316 can be any device or circuitry for determining the position of the client device 310. For example, the positioning module 316 can determine actual or relative position by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

As the player moves around with the client device 310 in the real world, the positioning module 316 tracks the position of the player and provides the player position information to the gaming module 314. The gaming module 314 updates the player position in the virtual world associated with the game based on the actual position of the player in the real world. Thus, a player can interact with the virtual world simply by carrying or transporting the client device 310 in the real world. In particular, the location of the player in the virtual world can correspond to the location of the player in the real world. The gaming module 314 can provide player position information to the game server 320 over the network 370. In response, the game server 320 may enact various techniques to verify the location of the client device 310 to prevent cheaters from spoofing their locations. It should be understood that location information associated with a player is utilized only if permission is granted after the player has been notified that location information of the player is to be accessed and how the location information is to be utilized in the context of the game (e.g., to update player position in the virtual world). In addition, any location information associated with players is stored and maintained in a manner to protect player privacy.

The localization module 318 provides an additional or alternative way to determine the location of the client device 310. In one embodiment, the localization module 318 receives the location determined for the client device 310 by the positioning module 316 and refines it by determining a pose of one or more cameras of the camera assembly 312. The localization module 318 may use the location generated by the positioning module 316 to select a 3D map of the environment surrounding the client device 310 and localize against the 3D map. The localization module 318 may obtain the 3D map from local storage or from the game server 320. The 3D map may be a point cloud, mesh, or any other suitable 3D representation of the environment surrounding the client device 310. Alternatively, the localization module 318 may determine a location or pose of the client device 310 without reference to a coarse location (such as one provided by a GPS system), such as by determining the relative location of the client device 310 to another device.

In one embodiment, the localization module 318 applies a trained model to determine the pose of images captured by the camera assembly 312 relative to the 3D map. Thus, the localization model can determine an accurate (e.g., to within a few centimeters and degrees) determination of the position and orientation of the client device 310. The position of the client device 310 can then be tracked over time using dead reckoning based on sensor readings, periodic re-localization, or a combination of both. Having an accurate pose for the client device 310 may enable the gaming module 314 to present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

The game server 320 includes one or more computing devices that provide game functionality to the client device 310. The game server 320 can include or be in communication with a game database 330. The game database 330 stores game data used in the parallel reality game to be served or provided to the client device 310 over the network 370.

The game data stored in the game database 330 can include: (1) data associated with the virtual world in the parallel reality game (e.g., image data used to render the virtual world on a display device, geographic coordinates of locations in the virtual world, etc.); (2) data associated with players of the parallel reality game (e.g., player profiles including but not limited to player information, player experience level, player currency, current player positions in the virtual world/real world, player energy level, player preferences, team information, faction information, etc.); (3) data associated with game objectives (e.g., data associated with current game objectives, status of game objectives, past game objectives, future game objectives, desired game objectives, etc.); (4) data associated with virtual elements in the virtual world (e.g., positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) game status (e.g., current number of players, current status of game objectives, player leaderboard, etc.); (7) data associated with player actions/input (e.g., current player positions, past player positions, player moves, player input, player queries, player communications, etc.); or (8) any other data used, related to, or obtained during implementation of the parallel reality game. The game data stored in the game database 330 can be populated either offline or in real time by system administrators or by data received from users (e.g., players), such as from a client device 310 over the network 370.

In one embodiment, the game server 320 is configured to receive requests for game data from a client device 310 (for instance via remote procedure calls (RPCs)) and to respond to those requests via the network 370. The game server 320 can encode game data in one or more data files and provide the data files to the client device 310. In addition, the game server 320 can be configured to receive game data (e.g., player positions, player actions, player input, etc.) from a client device 310 via the network 370. The client device 310 can be configured to periodically send player input and other updates to the game server 320, which the game server uses to update game data in the game database 330 to reflect any and all changed conditions for the game.

In the embodiment shown in FIG. 3, the game server 320 includes a universal game module 322, a commercial game module 323, a data collection module 324, an event module 326, a mapping system 327, and a 3D map store 329. As mentioned above, the game server 320 interacts with a game database 330 that may be part of the game server or accessed remotely (e.g., the game database 330 may be a distributed database accessed via the network 370). In other embodiments, the game server 320 contains different or additional elements. In addition, the functions may be distributed among the elements in a different manner than described.

The universal game module 322 hosts an instance of the parallel reality game for a set of players (e.g., all players of the parallel reality game) and acts as the authoritative source for the current status of the parallel reality game for the set of players. As the host, the universal game module 322 generates game content for presentation to players (e.g., via their respective client devices 310). The universal game module 322 may access the game database 330 to retrieve or store game data when hosting the parallel reality game. The universal game module 322 may also receive game data from client devices 310 (e.g., depth information, player input, player position, player actions, landmark information, etc.) and incorporates the game data received into the overall parallel reality game for the entire set of players of the parallel reality game. The universal game module 322 can also manage the delivery of game data to the client device 310 over the network 370. In some embodiments, the universal game module 322 also governs security aspects of the interaction of the client device 310 with the parallel reality game, such as securing connections between the client device and the game server 320, establishing connections between various client devices, or verifying the location of the various client devices 310 to prevent players cheating by spoofing their location.

The commercial game module 323 can be separate from or a part of the universal game module 322. The commercial game module 323 can manage the inclusion of various game features within the parallel reality game that are linked with a commercial activity in the real world. For instance, the commercial game module 323 can receive requests from external systems such as sponsors/advertisers, businesses, or other entities over the network 370 to include game features linked with commercial activity in the real world. The commercial game module 323 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 324 can be separate from or a part of the universal game module 322. The data collection module 324 can manage the inclusion of various game features within the parallel reality game that are linked with a data collection activity in the real world. For instance, the data collection module 324 can modify game data stored in the game database 330 to include game features linked with data collection activity in the parallel reality game. The data collection module 324 can also analyze data collected by players pursuant to the data collection activity and provide the data for access by various platforms.

The event module 326 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one embodiment, the mapping system 327 stores the 3D map along with any semantic/contextual information in the 3D map store 329. The 3D map may be stored in the 3D map store 329 in conjunction with location information (e.g., GPS coordinates of the center of the 3D map, a ringfence defining the extent of the 3D map, or the like). Thus, the game server 320 can provide the 3D map to client devices 310 that provide location data indicating they are within or near the geographic area covered by the 3D map.

The location verification module 328 verifies the pose of a client device by comparing the pose data received from the client device to images from the client device that are purported to have been captured at the same time as the pose data. While the description below may primarily describe verifying a pose of a client device, some embodiments may verify the location of a client device without verifying the client device's orientation.

To perform this comparison, the location verification module 328 receives pose data for the client device. For example, the pose data may include GNSS data indicating a global position of the client device, IMU data indicating an acceleration of the client device, or magnetometer data indicating a magnetic field measured by the client device. The pose data may be genuine pose data captured by sensors of the client device or may be spoofed pose data that is falsified by some spoofing system used by the user. Pose data that has not been verified, and therefore may be genuine or spoofed pose data, may be referred to herein as “ostensible pose data.”

The location verification module 328 also receives image data from the client device. The received image data describes an image that corresponds to the received pose data. That is, the received image is one that is captured at the same time as, or within some threshold time of, when the received pose data was supposedly captured by sensors. For example, the location verification module 328 may prompt the client device to capture the pose data using sensors of the client device and capture an image through a camera of the client device at the same time. As with the pose data, the received image data may describe a genuine image that was actually captured by the client device or may describe an image that was actually captured by another device (or by the client device but not in line with when the pose data was captured).

The location verification module 328 then uses a visual positioning system (VPS) model to determine whether the pose data and the received images match each other. The VPS model is a model that uses stored data describing images captured at different poses to serve as a reference to determine a pose for a particular image. For example, the VPS model may determine whether the received images match other images received from other client devices at the pose indicated by the pose data, or may determine whether the provided images match a 3D map of the area around the pose indicated by the pose data. In some embodiments, the VPS model includes some or all of the structure or functionality of the mapping system 327.

The location verification module 328 may determine whether the pose data and the received images match by comparing the pose data to a predicted pose from applying the VPS model to the received images. For example, if the predicted pose is some threshold difference from the received pose data, the location verification module 328 may determine that the pose data and the received images do not match.

If the location verification module 328 determines that the pose data and the received images do not match, the location verification module 328 determines that the client device is likely spoofing their pose data and takes some disciplinary action against the corresponding user. For example, the location verification module 328 may disable pose-based features or deactivating the user's account with the online system in response to determining that the client device is likely spoofing their pose data. The location verification module 328 may select a disciplinary action to apply to the corresponding user based on data describing the user's interactions with the online system. For example, if the user gained significant benefit (e.g., in-game benefits or financial benefits) from spoofing their pose data, the location verification module 328 may apply a more severe disciplinary action against the user than otherwise.

A client device may provide false images to the location verification module 328 in an attempt to trick the VPS system into determining that the client device is at a pose corresponding to the image. For example, to trick the online system into determining that a client device is at a landmark, a client device may download an image of a landmark that has been posted online and provide that image to the online system as the image captured by the client device. To counter this methodology, the location verification module 328 may require that the client device provide multiple sets of pose data and images to verify that the client device is not spoofing the online system. The location verification module 328 may compare the respective pose data with the respective images and determine whether the client device is spoofing any of the images or the pose data through the process described above. In some embodiments, the location verification module 328 also receives visual inertial odometry (VIO) data from the client device that indicates changes in the client device's pose over time, and uses the VIO data as another comparison with received images from the client device. For example, if a client device provides an image that matches with pose data from the client device, the location verification module 328 may instruct the client device to provide VIO data for a time period after that initial match. The location verification module 328 may compare the received VIO data to further received images from the client device. If the changes to the client device's pose, as indicated by the VIO data, do not align with the poses indicated by the images as determined by the VPS verification system, the location verification module 328 may determine that the client device is spoofing the VIO data or the images.

In some embodiments, the location verification module 328 may store previously received images and compare newly received images to the stored images to determine whether there is a match. If a newly received image matches a previously stored image, the location verification module 328 may determine that the client device is retransmitting the same image to spoof the location verification module 328. The location verification module 328 may use a hashing algorithm (e.g., a locality-sensitive hashing (LSH) algorithm) to hash received images and store them. The location verification module 328 may hash newly received images to identify stored images that are relatively similar to the newly received ones. If the location verification module 328 identifies a matching stored image to the newly received image, the location verification module 328 determines that the client device that transmitted the newly received image is likely retransmitting an image to spoof its pose.

In some embodiments, the location verification module 328 compares sensor data from multiple client devices with similar pose data to determine whether one of the client devices is an outlier and therefore is likely to be spoofing their pose data. For example, each client device may capture sensor data while in use. This sensor data may include magnetometer data, barometric data, cellphone signal strength data, WIFI network data (e.g., SSIDs of nearby networks), or raw GNSS data. The location verification module 328 may identify a subset of client devices that have poses that are near each other based on the pose data. The location verification module 328 may compare the sensor data captured by those client devices within a similar period of time and identify whether one of the client devices has sensor data that differs from the others. The location verification module 328 may determine that the client device with the different sensor data is likely spoofing its pose data. For example, if a client device is supposedly nearby several other client devices but has markedly different barometric readings from the other devices, that client device is likely spoofing their pose data and thus the location verification module 328 may identify the client device as such.

The location verification module 328 also may compare a client device's sensor data to publicly available data to determine whether the client device's sensor data matches that public data. If the client device's sensor data does not match the public data, the location verification module 328 may identify the client device as likely spoofing its pose.

The location verification module 328 may further compare a client device's sensor data to historical sensor data recorded by other client devices for an area to determine if the client device's sensor data is consistent with those other client devices. For example, the location verification module 328 may receive WIFI network data from client devices within an area and determine a set of WIFI networks that are detectable within that area. If the location verification module 328 receives a different set of WIFI networks that were detected by a client device within that area (e.g., an older set of WIFI networks, which may not all be detectable within the area), the location verification module 328 may determine that the client device is spoofing its pose.

In some embodiments, the location verification module 328 is limited in the number of images it can receive from client devices due to the large amount of bandwidth those images require to transmit and storage required to process them. Thus, the location verification module 328 may instruct client devices to individually store images corresponding to the client device's pose data for a time period. The client device may report the client device's pose trajectory during this time period and may be instructed by the location verification module 328 to capture and store images during this time period. For example, the location verification module 328 may instruct the client device to capture and store images for the last thirty seconds. The location verification module 328 may set an interval on which the images should be captured (e.g., every 0.1 seconds). The location verification module 328 may then occasionally request that the client device provide images corresponding to poses in the trajectory. For example, the location verification module 328 may identify certain timestamps within the time period and request that the client device provide images that correspond to the poses at those identified timestamps. The location verification module 328 may select the timestamps randomly within the timeframe, may select timestamps where the associated poses are some threshold distance apart from each other, or may select timestamps that correspond to a suspicious portion of the trajectory (e.g., where the trajectory is atypically straight or where the trajectory is substantially different from other portions of the trajectory). As described above, the location verification module 328 compares the VPS pose as determined based on the received images to the reported poses from the client device. If the respective poses do not match, the location verification module 328 determines that the client device is likely spoofing their pose.

In some embodiments, the location verification module 328 requests images for poses that are close enough in time to each other that the images should indicate a relatively small change in pose when a VPS model is applied to the images. For example, the location verification module 328 may request that the client device provide images that are 0.1 seconds apart from each other. The location verification module 328 may further require that the reported poses are at some minimum and maximum threshold distance from each other. The minimum distance ensures that the sequential images would ensure that the VPS model output poses that are confidently different, whereas the maximum distance ensures that the images be similar enough that they would have to be taken by the same client device within the same session. If the client device were spoofing its pose by providing fake images that the device did not actually capture, it is unlikely that the client device would be able to provide similar images that were allegedly taken close to each other in time without significant effort by the user. Thus, the location verification module 328 can detect spoofed poses or at least dissuade users from spoofing their poses by making it too difficult to avoid detection.

In some embodiments, once the location verification module 328 has verified that a client device is not spoofing its pose, the location verification module 328 assigns a digital signature to the client device that the client device can provide to other services within the online system to prove their veracity. The digital signature may be based on the client device's historical pose, the timestamps used to verify the device's pose, or an identifier for the user corresponding to the client device. The location verification module 328 may require that the client device provide a digital signature to access the pose-based features offered by the online system. By making the digital signature unique to a particular client device, the location verification module 328 can ensure that the digital signature cannot be shared among other client devices, and thereby prevent other devices from spoofing their pose using another client device's digital signature.

In some embodiments, the location verification module 328 adjusts how often a client device must verify its pose based on the location verification module 328's confidence in whether the client device is spoofing its pose. For example, the location verification module 328 may require a client device to verify its pose (e.g., as described above) when the client device connects to the online system for a session, and may allow the client device to continue to use services from the online system for the duration of the session. The location verification module 328 may adjust how often the client device must verify its pose based on how confident the location verification module 328 is that the client device is not spoofing. For example, if the location verification module 328 is very confident that the client device is not spoofing during a session, the location verification module 328 may allow the client device to start a new session without having to verify its pose. Alternatively, if the location verification module 328 is not very confident that the client device is not spoofing, the location verification module 328 may require the client device to verify its pose multiple times within a session.

The network 370 can be any type of communications network, such as a local area network (e.g., an intranet), wide area network (e.g., the internet), or some combination thereof. The network can also include a direct connection between a client device 310 and the game server 320. In general, communication between the game server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

### Example Methods

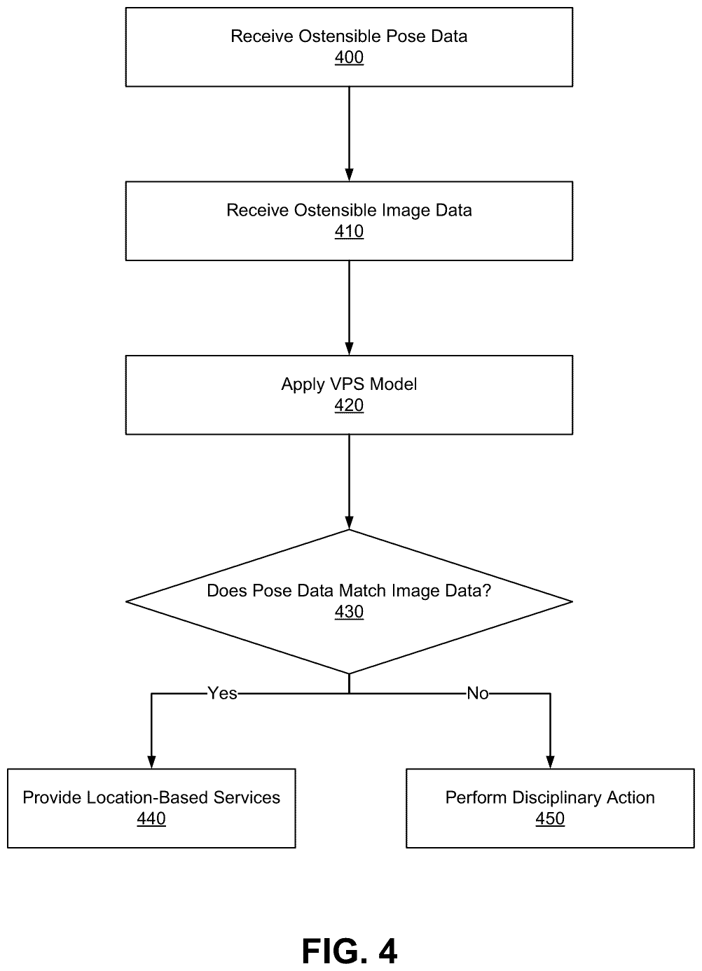

FIG. 4 is a flowchart describing an example method of location verification using a VPS model, according to one embodiment. The steps of FIG. 4 are illustrated from the perspective of the online system performing the method. However, some or all of the steps may be performed by other entities or components, such as a client device. In addition, some embodiments may perform the steps in parallel, perform the steps in different orders, or perform different steps.

The online system receives 400 ostensible pose data from a client device. The ostensible pose data is data that ostensibly describes a pose of the client device. The ostensible pose data may be pose data that was validly captured by the client device as part of normal use, or may be spoofed pose data that was captured by a different client device or by the client device at an earlier time than is reported in the ostensible pose data.

The online system receives 410 ostensible image data. The ostensible image data describes an image that was ostensibly captured by the client device at the time that the pose of the ostensible pose data was captured. The ostensible image data may be an image that was validly captured by the client device at the same time as the ostensible pose data, or may be spoofed image data that was captured at a different time or by a different device.

The online system applies 420 the VPS model to the ostensible pose data and the ostensible image data to determine 430 whether they match. For example, the online system may apply the VPS model to the ostensible image data to identify one or more candidate poses that at which the image in the image data may have been captured. The online system may compare these candidate poses to the ostensible pose data to determine how different the candidate poses are from the ostensible pose data. If the difference between the pose in the ostensible pose data and each of the candidate poses exceeds a threshold value, the online system determines that there was no match between the pose data and the image data. Similarly, if the pose in the ostensible pose data is within some threshold distance of one of the candidate poses, the online system determines that there was a match.

If there was a match between the ostensible pose data and the ostensible image data, the online system provides 440 location-based services to the client device. For example, the online system may continue to provide gaming services to the client device that use the client device's pose as part of the content that the client device receives from the online system. If there was no match, the online system performs 450 a disciplinary action with respect to the user associated with the client device. For example, the online system may disable location-based or pose-based services for the client device or may deactivate an account associated with the user.

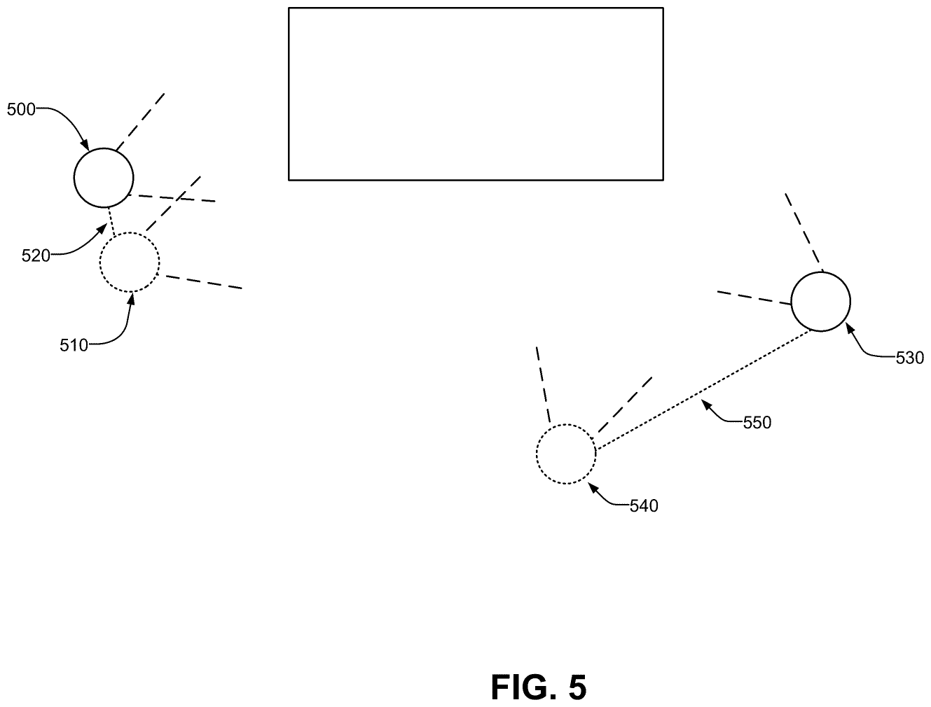

FIG. 5 illustrates examples of ostensible pose data and ostensible image data that match and that do not match, according to one embodiment. The online system may receive ostensible pose data that describes a first pose 500 and ostensible image data for an image that was ostensibly captured at the same time as the pose data. The online system applies a VPS model to the ostensible image data to predict a second pose 510 and compares the difference 520 between the first and second poses. Since the first and second poses are within some threshold difference, the online system may determine that there is a match between the pose data and the image data.

The online system may also receive ostensible pose data that describes a third pose 530 and corresponding ostensible image data. The online system applies the VPS model to this image data to predict a fourth pose 540. However, because the difference 550 between the third and fourth pose exceed a threshold, the online system determines that there was no match.

### ADDITIONAL CONSIDERATIONS

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate+/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by the following claims.

What is claimed is:

1. A method comprising:
receiving, by an online system, ostensible pose data, wherein the ostensible pose data is data that ostensibly describes a pose of a client device;
receiving ostensible image data, wherein the ostensible image data ostensibly describes an image captured by the client device while the client device is at the pose described by the ostensible pose data;
determining whether the ostensible pose data and the ostensible image data are valid by determining whether the ostensible pose data and the ostensible image data match by:
applying a VPS model to the ostensible image data, wherein the VPS model is a model that maps an image captured by a client device to possible poses that could correspond to that image; and
comparing an output of the VPS model to the ostensible pose data; and
responsive to determining that the ostensible pose data and the ostensible image data are not valid, performing a disciplinary action with regards to the client device.

2. The method of claim 1, wherein the pose data comprises GNSS data, magnetometer data, or IMU data.

3. The method of claim 1, further comprising:
transmitting an instruction to the client device to collect pose data and image data over a period of time.

4. The method of claim 3, wherein the received ostensible pose data and the received ostensible image data consists of pose data and image data from a set of timestamps within the period of time.

5. The method of claim 4, further comprising:
randomly selecting the set of timestamps within the period of time.

6. The method of claim 1, wherein determining whether the ostensible image data is valid comprises:
comparing the image of the ostensible image data to a set of images stored by the online system; and
responsive to determining, based on the comparing, that the image matches one of the set of images, determining that the image data is not valid.

7. The method of claim 6, wherein comparing the image to the set of images comprises:
applying a locality-sensitive hashing algorithm to the image.

8. The method of claim 1, wherein determining whether the ostensible pose data and the ostensible image data match comprises:
generating a set of candidate poses based on the ostensible image data and the VPS model; and
comparing the set of candidate poses to the pose described by the ostensible pose data.

9. The method of claim 8, wherein comparing the set of candidate poses to the pose of the ostensible pose data comprises:
computing a difference between each candidate pose and the pose of the ostensible pose data; and
responsive to the difference exceeding a threshold, determining that the ostensible pose data and the ostensible image data do not match.

10. The method of claim 1, further comprising:
responsive to determining that the ostensible pose data and the ostensible image data do match, providing pose-based services to the client device.

11. A non-transitory computer readable medium storing instructions that, when executed by a computing system, cause the computing system to perform steps comprising:
receiving, by an online system, ostensible pose data, wherein the ostensible pose data is data that ostensibly describes a pose of a client device;
receiving ostensible image data, wherein the ostensible image data ostensibly describes an image captured by the client device while the client device is at the pose described by the ostensible pose data;
determining whether the ostensible pose data and the ostensible image data are valid by determining whether the ostensible pose data and the ostensible image data match by:
applying a VPS model to the ostensible image data, wherein the VPS model is a model that maps an image captured by a client device to possible poses that could correspond to that image; and
comparing an output of the VPS model to the ostensible pose data; and
responsive to determining that the ostensible pose data and the ostensible image data are not valid, performing a disciplinary action with regards to the client device.

12. The computer-readable medium of claim 11, wherein the pose data comprises GNSS data, magnetometer data, or IMU data.

13. The computer-readable medium of claim 11, the steps further comprising:
transmitting an instruction to the client device to collect pose data and image data over a period of time.

14. The computer-readable medium of claim 13, wherein the received ostensible pose data and the received ostensible image data consists of pose data and image data from a set of timestamps within the period of time.

15. The computer-readable medium of claim 14, the steps further comprising:
randomly selecting the set of timestamps within the period of time.

16. The computer-readable medium of claim 11, wherein determining whether the ostensible image data is valid comprises:
comparing the image of the ostensible image data to a set of images stored by the online system; and
responsive to determining, based on the comparing, that the image matches one of the set of images, determining that the image data is not valid.

17. The computer-readable medium of claim 16, wherein comparing the image to the set of images comprises:
applying a locality-sensitive hashing algorithm to the image.

18. The computer-readable medium of claim 11, wherein determining whether the ostensible pose data and the ostensible image data match comprises:
generating a set of candidate poses based on the ostensible image data and the VPS model; and
comparing the set of candidate poses to the pose described by the ostensible pose data.

19. The computer-readable medium of claim 18, wherein comparing the set of candidate poses to the pose of the ostensible pose data comprises:
computing a difference between each candidate pose and the pose of the ostensible pose data; and
responsive to the difference exceeding a threshold, determining that the ostensible pose data and the ostensible image data do not match.

20. The computer-readable medium of claim 11, the steps further comprising:
responsive to determining that the ostensible pose data and the ostensible image data do match, providing pose-based services to the client device.
